(19) United States
(12) Patent Application Publication
(10) Pub. No.: US 2012/0157050 A1
(43) Pub. Date: Jun. 21, 2012

(54) METHOD OF CONTROLLING MACHINE TYPE COMMUNICATION DEVICE AND WIRELESS COMMUNICATION SYSTEM PROVIDING MACHINE TYPE COMMUNICATION SERVICE

(75) Inventors: Sook Yang KANG, Daejeon (KR); Moon Soo JANG, Daejeon (KR); Ae Soon PARK, Daejeon (KR)

(73) Assignee: Electronics and Telecommunications Research Institute, Daejeon (KR)

(21) Appl. No.: 13/331,736

(22) Filed: Dec. 20, 2011

(30) Foreign Application Priority Data
Dec. 21, 2010 (KR) 10-2010-0131996

(51) Int. Cl. H04W 12/06

(52) U.S. Cl. 455/411

(57) ABSTRACT

Provided are a method of controlling a machine type communication (MTC) device in a radio communication network providing an MTC service, and a wireless communication system providing an MTC service. The method includes registering an MTC device in an MTC server, performing, at the MTC server, authentication of an MTC user to be connected with the MTC device, requesting, at the MTC server, a state report on the MTC device requested by the MTC user from the MTC device and transmitting state information received from the MTC device to the MTC user, and performing, at the MTC server, service control for the MTC device according to a request of the MTC user.

### CLAIM FOR PRIORITY

This application claims priority to Korean Patent Application No. 10-2010-0131996 filed on Dec. 21, 2010 in the Korean Intellectual Property Office (KIPO), the entire contents of which are hereby incorporated by reference.

### BACKGROUND

1. Technical Field

Example embodiments of the present invention relate in general to a method of controlling a machine type communication (MTC) device in a radio communication network providing an MTC service and a wireless communication system providing an MTC service, and more particularly, to an MTC device control method of performing state tracing and service control for an MTC device in a Third Generation Partnership Project (3GPP) Long Term Evolution (LTE)-Advanced system and a wireless communication system using the method.

2. Related Art

MTC or machine-to-machine communication (M2M) is a form of data communication which involves one or more entities that do not necessarily need human interaction.

A service optimized for MTC differs from a service optimized for human-to-human communication. In comparison with a current mobile network communication service, the MTC service can be characterized by a) several market scenarios, b) data communications, c) lower cost and less effort, d) a potentially larger number of communicating terminals, e) a wider service area, and f) very low traffic per terminal.

MTC may be implemented in various forms of service. For example, MTC plays a great role in the fields of smart metering, tracking and tracing, remote maintenance and control, administration of physical distribution, remote monitoring of machine equipment, healthcare, and life tracking.

Lately, 3GPP has also been working on MTC standardization for intelligent communication between a human and an object and between objects. For various types of MTC applications having main functions of smart metering, remote control, etc., a huge number of MTC devices are disposed and managed.

In 3GPP as well, MTC technology based on an LTE-Advanced system is under discussion for standardization, but discussion on cases of use and some solutions has only just begun.

Among such services, an MTC monitoring service is intended for MTC devices installed at positions with high probability of being stolen or damaged, and provides a function for sensing an event that may have resulted from theft or damage. Likewise, no clear regulations on a function and operation have been made for the MTC monitoring service yet.

### SUMMARY

Accordingly, example embodiments of the present invention are provided to substantially obviate one or more problems due to limitations and disadvantages of the related art.

Example embodiments of the present invention provide a machine type communication (MTC) device control method for preventing theft and loss by preparing location tracking and administration functions for MTC in a variety of valuables and electronics, and for preventing outflow of personal information and an abnormal operation by limiting or terminating a service when an accident occurs, and a wireless communication system using the method.

In some example embodiments, a method of controlling an MTC device in a radio communication network providing an MTC service includes: registering the MTC device in an MTC server; requesting, at the MTC server, a home subscriber server (HSS) to perform authentication of an MTC user to be connected with the MTC device; requesting, at the MTC server, a state report on the MTC device requested by the MTC user from the MTC device, and transmitting state information received from the MTC device to the MTC user; and to performing, at the MTC server, service control for the MTC device according to a request of the MTC user.

Registering the MTC device in the MTC server may include: creating, at the MTC device, a session with the radio communication network; transmitting, at the MTC device, a registration request to the MTC server through the created session with the radio communication network; requesting, at the MTC server receiving the registration request, the HSS to register the MTC device; and performing, at the HSS receiving the MTC device registration request from the MTC server, registration of the MTC device.

Registering the MTC device in the MTC server may further include: after registration of the MTC device in the HSS, registering, at the MTC server, a request to monitor and report a state of the MTC device in the HSS.

The method may further include reporting, at the HSS in which the request to monitor and report the state of the MTC device has been registered, the state of the MTC device to the MTC server periodically or every time an event regarding the state of the MTC device occurs.

Requesting, at the MTC server, the state report on the MTC device requested by the MTC user from the MTC device, and transmitting the state information received from the MTC device to the MTC user may include: transmitting, at the MTC user, a state report request to the MTC server; calling, at the MTC server receiving the state report request, the MTC device by paging, and setting a radio bearer; transmitting, at the MTC device, a state report response including the state information on the MTC device itself to the MTC server through the set radio bearer; and forwarding, at the MTC server receiving the state report response, the state report response to the MTC user.

The state information on the MTC device may include information on at least one of a location of the MTC device, whether or not the MTC device has been turned off, and whether or not the MTC device has been damaged.

Performing, at the MTC server, the service control for the MTC device according to the request of the MTC user may include: transmitting, at the MTC user, the service control request including information on a service control type to the MTC server; and extracting, at the MTC server receiving the service control request, the information on the service control type included in the service control request and registering service limitation according to the extracted service control type in the HSS.

Performing, at the MTC server, the service control for the MTC device according to the request of the MTC user may include: calling, at the MTC server receiving the service control request, the MTC device by paging, and setting a radio bearer; and transmitting, at the MTC server, a service control message to the MTC device through the set radio bearer.

In other example embodiments, a wireless communication system providing an MTC service includes: at least one MTC device; an MTC user configured to manage the MTC device; an HSS configured to perform verification of the MTC device and authentication of the MTC user; and an MTC server configured to provide a service suited to characteristics of the at least one MTC device using registration information on the MTC device.

After registration of the MTC device in the MTC server and authentication of the MTC user are completed, the MTC server may perform a state report operation by requesting a state report on the MTC device requested by the MTC user and transmitting state information received from the MTC device to the MTC user, and perform a service control operation for the MTC device according to a request of the MTC user.

The MTC server may additionally register a request to monitor and report a state of the MTC device registered in the HSS in the HSS.

The HSS server in which the request to monitor and report the state of the MTC device has been registered may report the state of the MTC device to the MTC server periodically or every time an event regarding the state of the MTC device occurs.

The MTC server may receive the state report request for the MTC device, call the MTC device by paging, set a radio bearer, transmit a state report response including the state information on the MTC device received through the set radio bearer to the MTC user, and thereby perform the state report operation.

Also, the MTC server may receive the service control request, call the MTC device by paging, set a radio bearer, transmit a service control message to the MTC device through the set radio bearer to the MTC user, and thereby perform the service control operation.

The wireless communication system may further include a base station configured to handle setup and release of the radio bearer required for the state report operation or the service control operation.

Meanwhile, the MTC server receiving the service control request may extract information on a service control type included in the service control request, register service limitation according to the extracted service control type in the HSS, control the HSS to perform the service limitation, and thereby perform the service control operation for the MTC device.

### BRIEF DESCRIPTION OF DRAWINGS

Example embodiments of the present invention will become more apparent by describing in detail example embodiments of the present invention with reference to the accompanying drawings, in which:

FIG. 1 illustrates a radio communication network that provides a machine type communication (MTC) service to which example embodiments of the present invention are applied;

FIG. 2 shows a constitution of a network between an MTC device and an MTC server according to an example embodiment of the present invention;

FIG. 3 is a flowchart illustrating an attach process for registering an MTC device in a communication network and connecting the MTC device with an MTC user according to an example embodiment of the present invention;

FIG. 4 is a flowchart illustrating an operation of periodically tracking an MTC device according to an example embodiment of the present invention; and

FIG. 5 is a flowchart illustrating a process for an MTC user to perform a control operation for an MTC device according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

The term “terminal” used herein may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), moving node, mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

The term “base station” used herein generally denotes a fixed point communicating with a terminal, and may be referred to as a Node-B, evolved Node-B (eNB), base transceiver system (BTS), access point (AP), and other terms.

Hereinafter, example embodiments of the present invention will be described in detail with reference to the appended drawings. To aid in understanding the present invention, like numbers refer to like elements throughout the description of the figures, and the description of the same component will not be reiterated.

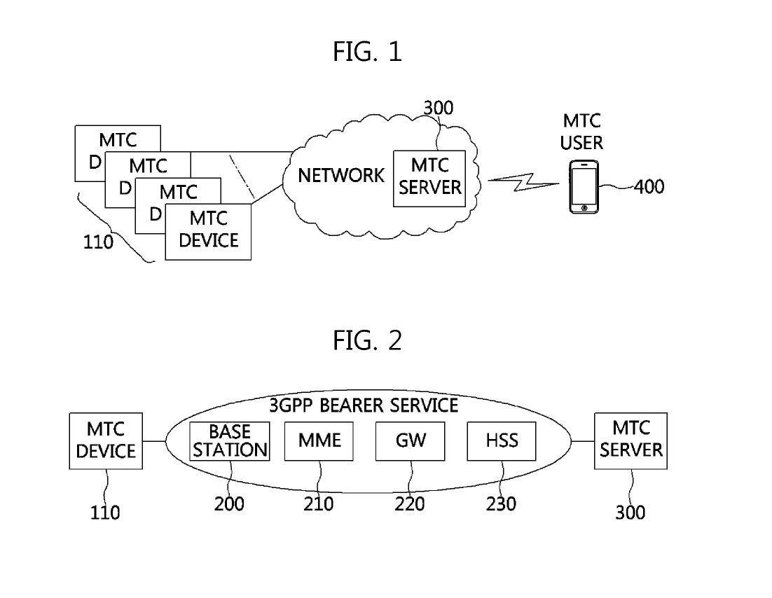

FIG. 1 illustrates a radio communication network that provides a machine type communication (MTC) service to which example embodiments of the present invention are applied.

As shown in FIG. 1, a radio communication network providing an MTC service includes an MTC server 300 for providing the MTC service, MTC devices 110, an MTC user 400, etc. in addition to an existing radio communication network.

In the present invention, objects in which a module implementing MTC technology is mounted are defined as the MTC devices 110, and a device having a function of controlling and managing the MTC device 110 is defined as the MTC user 400. The MTC devices 110 communicate with the MTC server 300 and each other.

The MTC server 300 communicates with the MTC devices 110 via a network. The MTC server 300 has an interface that can be accessed by the MTC user 400, and provides service for the MTC user 400. The MTC user 400 uses the service provided by the MTC server 300, and in an example embodiment of the present invention, manages and controls the MTC devices 110 through a cellular phone, and so on. Thus, the MTC user 400 may be connected with the MTC server 300 and at least one of the MTC devices 110 via a radio communication network.

In FIG. 1, the MTC server 300 is included in a network operator domain and thus controlled by a network operator. However, the MTC server 300 may be located not in the network operator domain but outside the network operator domain. In this case, the MTC server 300 is not controlled by the network operator.

Example embodiments of the present invention focus on management of objects that an individual has based on the communication network that provides the MTC service with such a constitution as an example of use of an MTC device.

By applying MTC technology to objects that may be damaged, lost, or stolen such as personal valuables, laptop computers and portable devices, locations and states of the objects may be traced and managed through a personal cellular phone.

In example embodiments of the present invention, when an MTC device leaves a specific location, a user may be notified of the fact, or an alarm may be sounded by the MTC device itself. Also, a location of an MTC device may be tracked by sending a signal from a portable terminal of an MTC user to the MTC device. When an MTC device is lost, the MTC device may send a signal to an MTC user so that the owner can find it. Devices such as a personal computer (PC), laptop computer, television, etc. may also be used for remote control such as remote use and service limitation.

Also, an example embodiment of the present invention provides a method for preventing outflow or misuse of personal information in the worst case by making an MTC to device unable to provide a service.

If a service needs to be resumed for an MTC device for which the service has been limited, the service limit may be cancelled by authentication of an MTC user, and the service may be restored.

In an example embodiment of the present invention, a location and state of an MTC device are periodically managed by a Long Term Evolution (LTE)-Advanced system. Also, a mobility management entity (MME) and home subscriber server (HSS) of a network statically/dynamically store and manage relations between MTC devices and an MTC user. To this end, example embodiments of the present invention generally provide the following three functions:
a function of registering a relation between an MTC device and an MTC user
a function of reporting a state at periods set in an MTC device or according to a request of an MTC user
a function for an MTC user to perform location tracking and service control for an MTC device via a network

A constitution of an example embodiment of the present invention will be described in detail below with reference to the appended drawings.

FIG. 2 shows a constitution of a network between an MTC device and an MTC server according to an example embodiment of the present invention.

An MTC device 110 in which an LTE-Advanced terminal protocol is installed is provided with a basic bearer service via a Third Generation Partnership Project (3GPP) communication network. The 3GPP bearer service is performed via the 3GPP communication network including an eNB 200, an MME 210, a gateway (GW) 220, and an HSS 230.

A wireless communication system including the components shown in FIG. 2 according to an example embodiment of the present invention particularly includes at least one MTC device, an MTC user which manages the MTC device, an HSS which handles authentication of the MTC device, and an MTC server which performs authentication of the MTC user, has registration information on the MTC device, and provides a service suited to characteristics of the at least one MTC device.

Additionally, the wireless communication system according to an example embodiment of the present invention may include a base station, a GW, an MME, etc. as shown in FIG. 2.

The base station 200 handles setup and release of a radio bearer, and the MME 210 handles registration and management of a location of the MTC device 110. The GW 220 serves as a GW to an external network or the MTC server 300. The HSS 230 handles verification of the MTC device 110, and stores correlation information, etc. between an MTC user 400 and the MTC device 110 that the MTC user 400 manages with interest. The MTC server 300 serves to provide a service suited to characteristics of the MTC device 110.

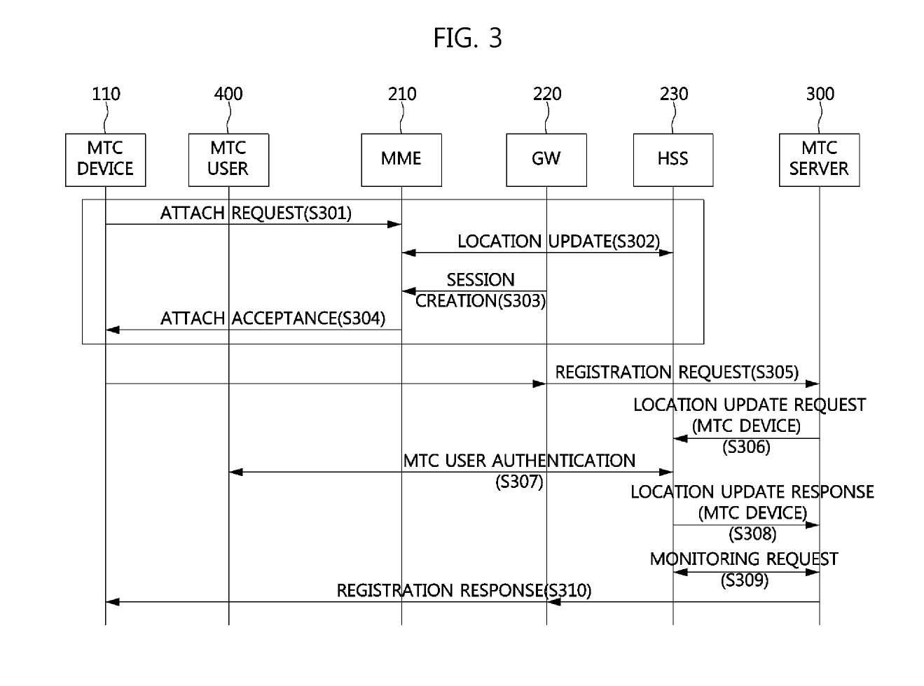

FIG. 3 is a flowchart illustrating an attachment process for registering an MTC device in a communication network and connecting the MTC device with an MTC user according to an example embodiment of the present invention.

An MTC device 110 can operate without intervention of a user, and an MTC user 400 may control and manage the MTC device 110. Here, the user intervention is made through a cellular phone.

The MTC device 110 in which a basic protocol of an LTE-Advanced terminal is installed is registered in a network through the same procedures as basic 3GPP access procedures, that is, attach request (S301), location update (S302), session creation (S303), and attach acceptance (S304).

Here, when a connection needs to be additionally established between the MTC device 110 and the MTC user 400, the MTC device 110 receiving attach acceptance performs an application-level registration process with an MTC server 300 (S305). The MTC device to 110 may perform a service suited to the MTC device 110 itself through registration with the MTC server 300.

An example embodiment of the present invention for management of the MTC device 110 involves authentication and registration procedures between the MTC device 110 and the MTC user 400.

When the MTC device 110 transmits a registration request to the MTC server 300, the MTC server 300 receives the registration request and requests an HSS 230 to perform a verification procedure on the MTC device 110. The HSS 230 completes authentication of the MTC user 400 and notifies the MTC server 300 of the authentication result.

Specifically, to authenticate the MTC user 400 to be connected with the MTC device 110 and verify a profile of the MTC user 400, the MTC server 300 performs a procedure of registering the MTC device 110 in the HSS 230 (S306). The HSS 230 performs the authentication procedure for the corresponding subscriber (S307), and notifies the MTC server whether or not registration has been performed (S308). Also, the MTC server 300 requests the HSS 230 to perform monitoring (S309). In other words, the MTC server 300 requests the HSS 230 to report a change in a location of the MTC device 110 and a state such as power off to the MTC server 300. The MTC server 300 finally notifies the MTC device 110 of registration completion (S310), and collects monitoring information periodically or according to an event.

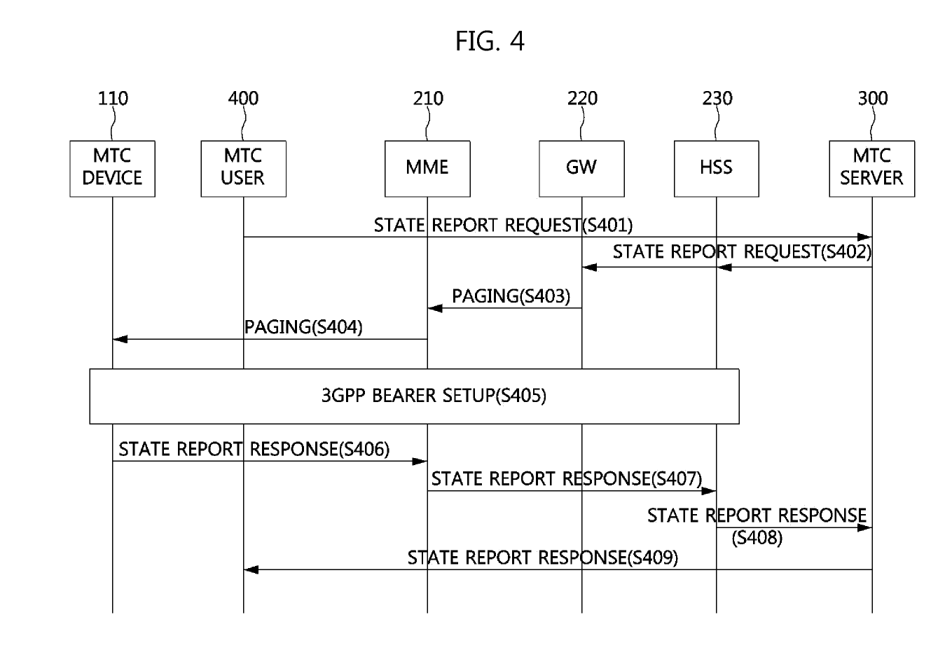

FIG. 4 is a flowchart illustrating an operation of periodically tracking an MTC device according to an example embodiment of the present invention.

Periodic tracking of an MTC device may be requested by a network or MTC user.

As illustrated in FIG. 3, if the MTC device 110 is registered in the HSS 230 upon attachment of the MTC device 110 to a network, the MTC server 300 may additionally register a notification request in the HSS 230.

FIG. 4 illustrates that it is possible to be notified of a state of an MTC device 110 (S406, S407, S408 and S409) by registering the notification request in an HSS 230 or an MME 210. Meanwhile, in another example embodiment of the present invention, a state of the MTC device 110 may be reported through an MTC server 300 by a request of an MTC user 400 (S401, S402, S403 and S404).

A case in which an MTC user directly request state information on an MTC device will be described here.

In this case, first, the MTC user 400 transmits a request for state information on the MTC device 110 or a request to call the MTC device 110 to the MTC server 300 (S401). The MTC server 300 receiving the request forwards the state report request to the HSS 230, and the HSS 230 forwards the state report request again to a GW 220 (S402). The GW 220 performs paging (S403) to call the MTC device 110 through the MME 210 (S404), thereby requesting state information from the MTC device 110. At this time, if no 3GPP radio bearer has been set, setup of a 3GPP radio bearer is performed first by paging (S405).

When setup of a 3GPP radio bearer is completed, a report on a location, state, etc. of the MTC device 110 is transmitted from the MTC device 110 to the MTC server 300 through the MME 210 and the HSS 230 using the 3GPP radio bearer (S406, S407 and S408). Here, the state information on the MTC device 110 may include information on at least one of a location of the MTC device 110, whether or not the MTC device 110 has been turned off, and whether or not the MTC device 110 has been damaged. The MTC server 300 transmits the information received from the MTC device 110 to the MTC user 400 (S409).

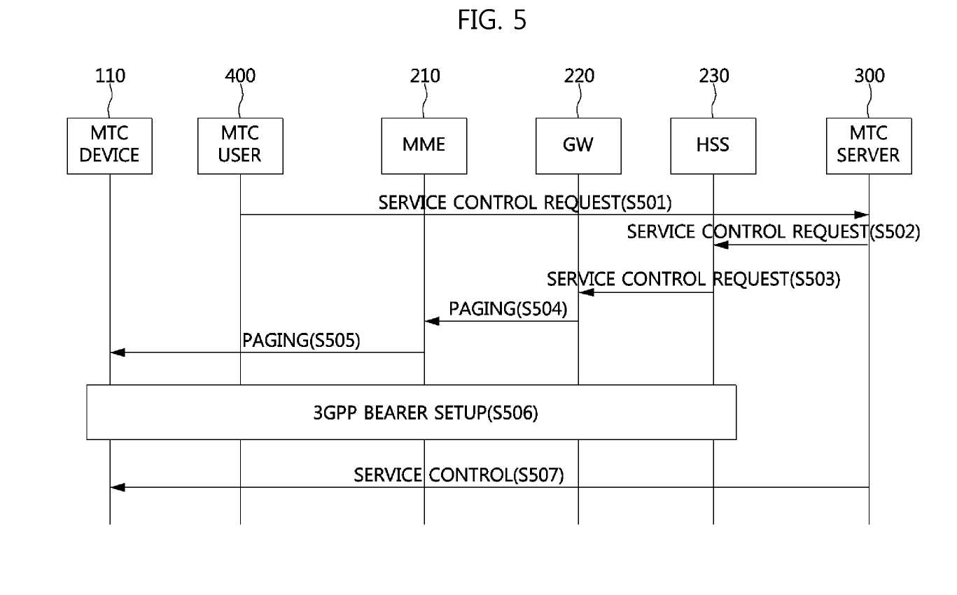

FIG. 5 is a flowchart illustrating a process for an MTC user to perform a control operation for an MTC device according to an example embodiment of the present invention.

The example embodiment of the present invention illustrated in FIG. 5 is intended to protect personal information and prevent an abnormal state by limiting or terminating a service when an MTC device is stolen or lost or malfunctions.

In an example embodiment of the present invention, a function of remotely controlling a device may also be performed. In this case, an MTC device 110 has accurate service control performed through an authentication procedure, etc. with an MTC user 400.

The MTC user 400 transmits a service control request to an MTC server 300 (S501), thereby controlling the MTC device 110. At this time, information on a service control type may be included in the service control request message. In other words, the MTC server 300 may request an HSS 230 to limit a service corresponding to the service control type requested by the MTC user 400 (S502). Alternatively, the MTC server 300 calls (pages) the MTC device 110 through a GW 220 and an MME 210, thereby performing direct control (S503, S504 and S505). Direct control denotes an operation of connecting to the MTC device 110 to sound a proper alarm or take appropriate measures such as service limitation.

When setup of a 3GPP bearer is completed (S506), the MTC server 300 forwards a control message transmitted by the MTC user 400 to the MTC device 110, thereby controlling the MTC device 110 (S507). A procedure of canceling a service limit is performed in the same way.

Example embodiments of the present invention provide a method for an MTC user to manage and track various MTC devices, so that loss and theft of the MTC devices can be prevented and the MTC user can control the devices. Consequently, example embodiments of the present invention can be employed in various fields such as remote appliance control, and care for the elderly and infirm.

While the example embodiments of the present invention and their advantages have been described in detail, it should be understood that various changes, substitutions and alterations may be made herein without departing from the scope of the invention.

What is claimed is:

1. A method of controlling a machine type communication (MTC) device in a radio communication network providing an MTC service, the method comprising:
registering the MTC device in an MTC server;
requesting, at the MTC server, a home subscriber server (HSS) to perform authentication of an MTC user to be connected with the MTC device;
requesting, at the MTC server, a state report on the MTC device requested by the MTC user from the MTC device, and transmitting state information received from the MTC to device to the MTC user; and
performing, at the MTC server, service control for the MTC device according to a request of the MTC user.

2. The method of claim 1, wherein registering the MTC device in the MTC server includes:
creating, at the MTC device, a session with the radio communication network;
transmitting, at the MTC device, a registration request to the MTC server through the created session with the radio communication network;
requesting, at the MTC server receiving the registration request, the HSS to register the MTC device; and
performing, at the HSS receiving the MTC device registration request from the MTC server, registration of the MTC device.

3. The method of claim 2, wherein registering the MTC device in the MTC server further includes, after registration of the MTC device in the HSS, registering, at the MTC server, a request to monitor and report a state of the MTC device in the HSS.

4. The method of claim 3, further comprising reporting, at the HSS in which the request to monitor and report the state of the MTC device has been registered, the state of the MTC device to the MTC server periodically or every time an event regarding the state of the MTC device occurs.

5. The method of claim 1, wherein requesting, at the MTC server, the state report on the MTC device requested by the MTC user from the MTC device, and transmitting the state information received from the MTC device to the MTC user include:
transmitting, at the MTC user, a state report request to the MTC server;
calling, at the MTC server receiving the state report request, the MTC device by paging, and setting a radio bearer;
transmitting, at the MTC device, a state report response including the state information on the MTC device itself to the MTC server through the set radio bearer; and
forwarding, at the MTC server receiving the state report response, the state report response to the MTC user.

6. The method of claim 1, wherein the state information on the MTC device includes information on at least one of a location of the MTC device, whether or not the MTC device has been turned off, and whether or not the MTC device has been damaged.

7. The method of claim 1, wherein performing, at the MTC server, the service control for the MTC device according to the request of the MTC user includes:
transmitting, at the MTC user, the service control request including information on a service control type to the MTC server; and
extracting, at the MTC server receiving the service control request, the information on the service control type included in the service control request and registering service limitation according to the extracted service control type in the HSS.

8. The method of claim 1, wherein performing, at the MTC server, the service control for the MTC device according to the request of the MTC user includes:
calling, at the MTC server receiving the service control request, the MTC device by paging, and setting a radio bearer; and
transmitting, at the MTC server, a service control message to the MTC device through the set radio bearer.

9. A wireless communication system providing a machine type communication (MTC) service, comprising:
at least one MTC device;
an MTC user configured to manage the MTC device;
a home subscriber server (HSS) configured to perform verification of the MTC device and authentication of the MTC user; and
an MTC server configured to provide a service suited to characteristics of the at least one MTC device using registration information on the MTC device,
wherein, after registration of the MTC device in the MTC server and authentication of the MTC user are completed, the MTC server performs a state report operation by requesting a state report on the MTC device requested by the MTC user and transmitting state information received from the MTC device to the MTC user, and performs a service control operation for the MTC device according to a request of the MTC user.

10. The wireless communication system of claim 9, wherein the MTC server additionally registers a request to monitor and report a state of the MTC device registered in the HSS in the HSS.

11. The wireless communication system of claim 10, wherein the HSS server in which the request to monitor and report the state of the MTC device has been registered reports the state of the MTC device to the MTC server periodically or every time an event regarding the state of the MTC device occurs.

12. The wireless communication system of claim 9, wherein the MTC server receives the state report request for the MTC device, calls the MTC device by paging, sets a radio bearer, transmits a state report response including the state information on the MTC device received through the set radio bearer to the MTC user, and thereby performs the state report operation; and
receives the service control request, calls the MTC device by paging, sets a radio bearer, transmits a service control message to the MTC device through the set radio bearer to the MTC user, and thereby performs the service control operation.

13. The wireless communication system of claim 12, further comprising a base station configured to handle setup and release of the radio bearer required for the state report operation or the service control operation.

14. The wireless communication system of claim 11, wherein the MTC server receiving the service control request extracts information on a service control type included in the service control request, registers service limitation according to the extracted service control type in the HSS, controls the HSS to perform the service limitation, and thereby performs the service control operation for the MTC device.
